(19) United States
(12) Patent Application Publication
(10) Pub. No.: US 2023/0418557 A1
(43) Pub. Date: Dec. 28, 2023

(54) DATA COMPUTATION CIRCUIT AND METHOD

(71) Applicant: TAIWAN SEMICONDUCTOR MANUFACTURING COMPANY, LTD., Hsinchu (TW)

(72) Inventors: Chia-Fu LEE, Hsinchu (TW); Cheng Han LU, Hsinchu (TW); Yu-Der CHIH, Hsinchu (TW); Jonathan Tsung-Yung CHANG, Hsinchu (TW); Yen-Huei CHEN, Hsinchu (TW); Chen-En LEE, Hsinchu (TW); Wei-Chang ZHAO, Hsinchu (TW); Haruki MORI, Hsinchu (TW); Hidehiro FUJIWARA, Hsinchu (TW)

(21) Appl. No.: 18/157,252

(22) Filed: Jan. 20, 2023

Related U.S. Application Data
(60) Provisional application No. 63/356,146, filed on Jun. 28, 2022.

(51) Int. Cl. G06F 7/501; G06F 7/49

(52) U.S. Cl. CPC G06F 7/501; G06F 7/49

(57) ABSTRACT

A circuit includes a multiplier circuit that receives a signed mantissa of each data element of pluralities of input and weight data elements and generates two's complement products by performing multiplication and reformatting operations on some or all of the input data element signed mantissas and some or all of the weight data element signed mantissas, a summing circuit that receives an exponent of each data element of the pluralities of input and weight data elements and generates sums by adding each input data element exponent to each weight data element exponent, a shifting circuit that shifts each product by an amount equal to a difference between a corresponding sum and a maximum sum, and an adder tree that generates a mantissa sum from the shifted products.

### PRIORITY CLAIM

The present application claims the priority of U.S. Provisional Application No. 63/356,146, filed Jun. 28, 2022, which is incorporated herein by reference in its entirety.

### BACKGROUND

Memory arrays are often used to store and access data used for various types of computations such as logic or mathematical operations. To perform these operations, data bits are moved between the memory arrays and circuits used to perform the computations. In a compute-in-memory (CIM) circuit, the memory array is combined with the computation circuit(s). In some cases, computations include multiple layers of operations, and the results of a first operation are used as input data in a second operation.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A and 1B are schematic diagrams of a data computation circuit, in accordance with some embodiments.

FIG. 2 is a schematic diagram of a shifting circuit, in accordance with some embodiments.

FIG. 3 is a diagram of data elements of a shifting circuit, in accordance with some embodiments.

FIG. 4 is a schematic diagram of a shifting circuit, in accordance with some embodiments.

FIG. 5 is a diagram of data elements of a shifting circuit, in accordance with some embodiments.

FIG. 6 is a diagram of data elements of a shifting circuit, in accordance with some embodiments.

FIG. 7 is a flowchart of a method of operating a circuit, in accordance with some embodiments.

FIG. 8 is a schematic diagram of a compute-in-memory circuit, in accordance with some embodiments.

FIG. 9 is a flowchart of a method of operating a memory circuit, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In various embodiments, a data computation circuit, e.g., a compute-in-memory (CIM) circuit, is configured to perform data computations by separating sign and mantissa bits from exponent bits of input and weight data elements. A multiplier circuit performs multiplication and reformatting operations on the sign and mantissa bits of the input and weight data elements to generate two's complement products, and a summing circuit adds the exponents of the input data to those of the weight data to generate sums. A shifting circuit shifts the products based on differences between the sums and a maximum sum, and an adder tree adds the shifted products together to produce a partial sum. The data computation circuit is thereby configured to perform floating point partial sum computations using less time, area, and power than in other approaches, and without quantization errors present in some approaches in which floating point data are converted to fixed point data. In some embodiments, the shifter circuit employs a two-stage configuration to further reduce area and simplify routing requirements.

In some embodiments, a CIM circuit includes a partial sum buffer configured to accumulate multiple partial sum data elements prior to being output, e.g., to an external memory array, thereby reducing access power and time requirements compared to approaches in which individual partial sum data elements are output.

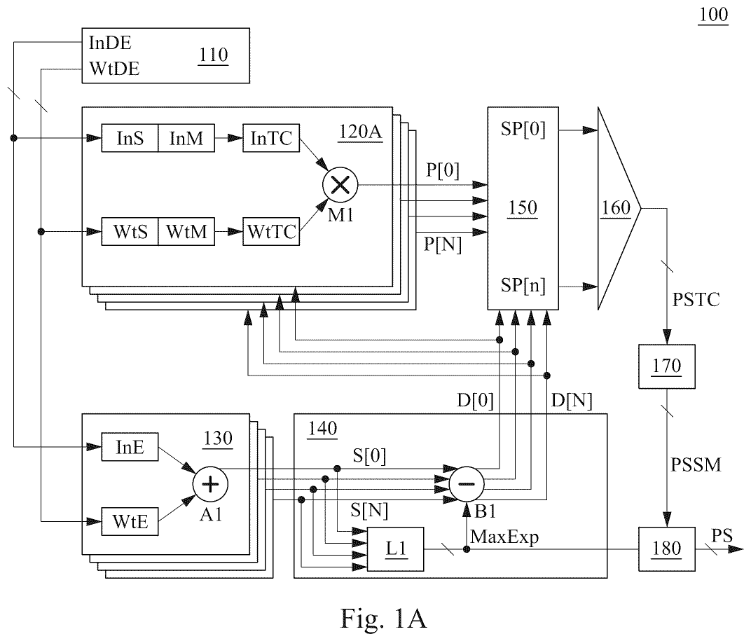

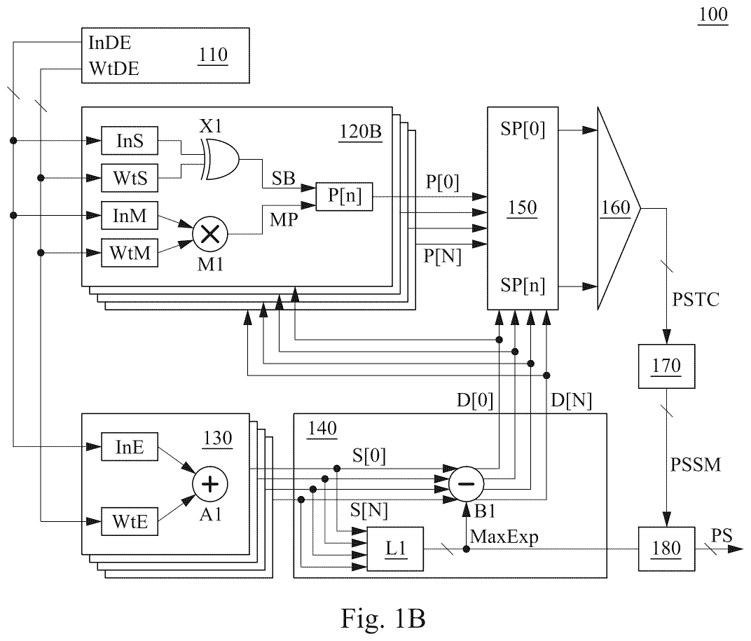

Each of FIGS. 1A and 1B is a schematic diagram of a data computation circuit 100, in accordance with some embodiments. In the embodiment depicted in FIG. 1A, data computation circuit 100, also referred to as circuit 100 or memory circuit 100 in some embodiments, includes a memory array 110, a multiplier circuit 120A, a summing circuit 130, a difference circuit 140, a shifting circuit 150, an adder tree 160, and converters 170 and 180. In the embodiment depicted in FIG. 1B and discussed below, circuit 100 includes a multiplier circuit 120B instead of multiplier circuit 120A, and is otherwise configured in accordance with the embodiment discussed below with respect to FIG. 1A.

In the embodiment depicted in FIG. 1A, memory array 110 is coupled to each of multiplier circuit 120A and summing circuit 130; summing circuit 130 is further coupled to difference circuit 140; difference circuit 140 is further coupled to each of multiplier circuit 120A, shifting circuit 150, and converter 180; shifting circuit 150 is further coupled to adder tree 160; adder tree 160 is further coupled to converter 170; and converter 170 is further coupled to converter 180.

Two or more circuit elements are considered to be coupled based on a direct electrical connection or an electrical connection that includes one or more additional circuit elements and is thereby capable of being controlled, e.g., made resistive or open by one or more transistors or other switching devices.

The embodiment depicted in FIG. 1A is a non-limiting example provided for the purpose of illustration. In some embodiments, circuit 100 has a configuration other than that depicted in FIG. 1A whereby the benefits discussed below are capable of being realized. In some embodiments, circuit 100 does not include memory array 110, and each of multiplier circuit 120A and summing circuit 130 is coupled to a circuit, e.g., a memory array, external to circuit 100. In some embodiments, circuit 100 does not include one or both of converters 170 or 180. In some embodiments, difference circuit 140 is not further coupled to multiplier circuit 120A.

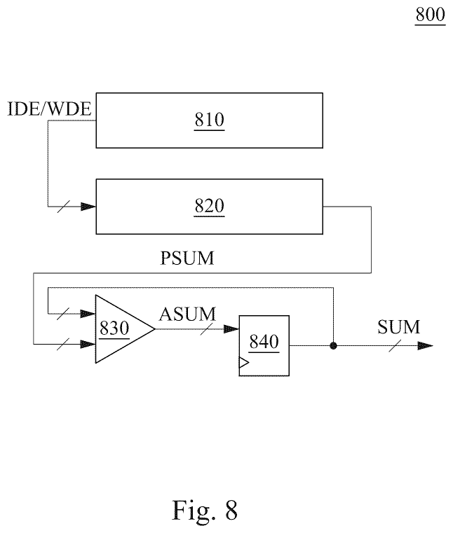

In some embodiments, circuit 100 includes circuit elements in addition to those depicted in FIG. 1A and discussed below, e.g., a control circuit or additional instances of the depicted circuit elements. In some embodiments, circuit 100 includes an adder 830 and buffer 840 configured as discussed below with respect to FIG. 8.

In some embodiments, the elements depicted in FIG. 1A are a portion of a memory circuit including multiple instances of memory array 110, multiplier circuit 120A, summing circuit 130, difference circuit 140, shifting circuit 150, adder tree 160, and/or converters 170 and/or 180.

In some embodiments, circuit 100 is included in a CIM circuit including elements configured to perform in-memory computations, e.g., a convolutional neural network (CNN) in which arrays, e.g., memory array 110, include stored weight data elements, e.g., a plurality of data elements WtDE, that are applied in multiply and accumulate (MAC) operations to one or more sets of input data elements, e.g., a plurality of data elements InDE.

A memory array, e.g., memory array 110 or memory array 810 discussed below with respect to FIG. 8, is a storage device including a plurality of storage elements, each storage element including an electrical, electromechanical, electromagnetic, or other device configured to store one or more data elements, each data element including one or more data bits represented by logical states. In some embodiments, a logical state corresponds to a voltage level of an electrical charge stored in a portion or all of a storage element. In some embodiments, a logical state corresponds to a physical property, e.g., a resistance or magnetic orientation, of a portion or all of a storage element.

In some embodiments, the storage element includes one or more static random-access memory (SRAM) cells. In various embodiments, an SRAM cell, e.g., a five-transistor (5T), six-transistor (6T), eight-transistor (8T), or nine-transistor (9T) SRAM cell, includes a number of transistors ranging from two to twelve. In some embodiments, an SRAM cell includes a multi-track SRAM cell. In some embodiments, an SRAM cell includes a length at least two times greater than a width.

In some embodiments, the storage element includes one or more dynamic random-access memory (DRAM) cells, resistive random-access memory (RRAM) cells, magnetoresistive random-access memory (MRAM) cells, ferroelectric random-access memory (FeRAM) cells, NOR flash cells, NAND flash cells, conductive-bridging random-access memory (CBRAM) cells, data registers, non-volatile memory (NVM) cells, 3D NVM cells, or other memory cell types capable of storing bit data.

Memory array 110 is configured to store data elements InDE, also referred to as input data elements InDE, and data elements WtDE, also referred to as weight data elements WtDE. In some embodiments in which circuit 100 is included in a CIM circuit, input data elements InDE and weight data elements WtDE correspond to respective input and weight data of one or more matrix computations.

In some embodiments, plurality of input data elements InDE is one of multiple pluralities of input data elements, and memory array 110 is configured to store each plurality of the multiple pluralities of input data elements. In some embodiments, plurality of weight data elements WtDE is one of multiple pluralities of weight data elements, and memory array 110 is configured to store each plurality of the multiple pluralities of weight data elements.

As each of the numbers of data elements and bits per data element stored in memory array 110 increases, circuit complexity and power consumption increase along with functional capabilities, e.g., increased weight data resolution.

In the embodiment depicted in FIG. 1A, memory array 110 includes a total of four data elements of each of data elements InDE and WtDE. In some embodiments, memory array 110 includes data elements InDE and WtDE having total numbers of data elements that are the same or different from each other. In some embodiments, memory array 110 includes fewer or greater than four data elements of one or both of data elements InDE and WtDE. In some embodiments, memory array 110 includes the number of data elements of one or both of data elements InDE and WtDE ranging from two to 1024. In some embodiments, memory array 110 includes the number of data elements of one or both of data elements InDE and WtDE ranging from two to 128.

In the embodiment depicted in FIG. 1A, memory array 110 is configured to store a number of bits of each data element of data elements InDE and WtDE equal to sixteen. In some embodiments, memory array 110 is configured to store a number of bits of each data element of data elements InDE and WtDE ranging from four to 256. In some embodiments, memory array 110 is configured to store a number of bits of each data element of data elements InDE and WtDE ranging from eight to 64. In some embodiments, memory array 110 is configured to store a number of bits of each data element of data elements InDE and WtDE equal to sixteen.

In the embodiment depicted in FIG. 1A, each data element of data elements InDE and WtDE has a binary floating-point computer number format including a sign bit, a plurality of exponent bits, and a plurality of mantissa bits, also referred to as a plurality of fraction bits in some embodiments.

In some embodiments, each data element of data elements InDE and WtDE has a BF16 format, also referred to as a bfloat format or brain floating-point format in some embodiments, in which a first bit represents a sign of a floating-point number, a subsequent eight bits represent an exponent of the floating-point number, and the final seven bits represent the mantissa, or fraction, of the floating-point number. Because the mantissa is configured to start with a non-zero value, the final seven bits of each stored data element represent an eight-bit mantissa having a first, most significant bit (MSB) equal to one.

In some embodiments, each data element of data elements InDE and WtDE has a FP16 format, also referred to as a half precision format in some embodiments, in which a first bit represents a sign of a floating-point number, a subsequent five bits represent an exponent of the floating-point number, and the final ten bits represent the mantissa, or fraction, of the floating-point number. In this case, the final ten bits of each stored data element represent an eleven-bit mantissa having a first MSB equal to one.

In some embodiments, each data element of data elements InDE and WtDE has a floating-point format other than a BF16 or FP16 format, e.g., another 16-bit format, a 32-bit, 64-bit, 128-bit, or 256-bit format, or a 40-bit or 80-bit extended precision format.

In some embodiments, the sign and mantissa of a data element representing a floating-point number are collectively referred to as a signed mantissa of the floating-point number. In some embodiments, the MSB of a mantissa is referred to as a hidden bit or hidden MSB.

Memory array 110 includes one or more I/O connections (not shown) through which the logical states are programmed in write operations and accessed in read operations. Memory array 110 is configured to, in the read operations, output some or all of each data element of data elements InDE and WtDE to each of multiplier circuit 120A and summing circuit 130 on one or more data buses (not labeled). In some embodiments, memory array 110 is configured to output entireties of each data element of data elements InDE and WtDE to each of multiplier circuit 120A and summing circuit 130. In some embodiments, memory array 110 is configured to output only the signed mantissa of each data element to multiplier circuit 120A and the exponent of each data element to summing circuit 130.

Multiplier circuit 120A is an electronic circuit, e.g., an integrated circuit (IC), configured to receive, e.g., from memory array 110, a sign bit InS and a mantissa InM (collectively a signed mantissa InS/InM) of each data element of data elements InDE, and a sign bit WtS and a mantissa WtM (collectively a signed mantissa WtS/WtM) of each data element of data elements WtDE. Summing circuit 130 is an electronic circuit, e.g., an IC, configured to receive, e.g., from memory array 110, an exponent InE of each data element of data elements InDE, and an exponent WtE of each data element of data elements WtDE.

Multiplier circuit 120A includes one or more data registers (not labeled) configured to receive the instances of signed mantissas InS/InM and WtS/WtM. In the embodiment depicted in FIG. 1A, multiplier circuit 120A is configured to receive the instances of signed mantissas InS/InM and WtS/WtM corresponding to data elements InDE and WtDE each having a total of four data elements. In some embodiments, multiplier circuit 120A is configured to receive the instances of signed mantissas InS/InM and WtS/WtM corresponding to one or both of data elements InDE and WtDE having a total number fewer or greater than four.

In some embodiments, multiplier circuit 120A includes the one or more data registers configured to receive the instances of signed mantissas InS/InM and/or WtS/WtM including the hidden MSBs. In some embodiments, multiplier circuit 120A includes the one or more data registers configured to add the hidden MSBs to the received instances of signed mantissas InS/InM and/or WtS/WtM.

Multiplier circuit 120A includes logic circuitry (not shown) configured to, in operation, reformat each instance of signed mantissa InS/InM to a two's complement mantissa InTC, also referred to as reformatted mantissa InTC, and to reformat each instance of signed mantissa WtS/WtM to a two's complement mantissa WtTC, also referred to as reformatted mantissa WtTC. Reformatted mantissa InTC has a same number of bits as signed mantissa InS/InM, and reformatted mantissa WtTC has a same number of bits as signed mantissa WtS/WtM.

Multiplier circuit 120A includes one or more logic gates M1 configured to, in operation, multiply some or all of the instances of reformatted mantissas InTC with some or all of the instances of reformatted mantissas WtTC, thereby generating a number N+1 of products P[0]-P[N]. In various embodiments, the one or more logic gates M1 include one or more AND or NOR gates or other circuits suitable for performing some or all of a multiplication operation. The one or more logic gates M1 are configured to, in operation, generate each product P[0]-P[N] as a two's complement data element including a number of bits equal to twice the number of bits of reformatted mantissas InTC and WtTC minus one.

Multiplier circuit 120A is configured to, in operation, generate the number N+1 of products P[0]-P[N] equal to the number of data elements of data elements InDE times the number of data elements of data elements WtDE. In the embodiment depicted in FIG. 1A, multiplier circuit 120A is configured to generate the number N+1 of products P[0]-P[N] equal to sixteen. In some embodiments, multiplier circuit 120A is configured to generate the number N+1 of products P[0]-P[N] fewer or greater than sixteen. In some embodiments, multiplier circuit 120A is configured to generate products P[0]-P[N] having the number equal to N+1 conditioned on a first difference threshold, as discussed below with respect to difference circuit 140 and shifting circuit 150.

In some embodiments, e.g., those in which data elements InDE and WtDE have the BF16 format, multiplier circuit 120A is configured to generate each of products P[0]-P[N] having a total of 17 bits based on each of signed mantissas InS/InM and WtS/WtM and reformatted mantissas InTC and WtTC having a total of nine bits. In some embodiments, e.g., those in which data elements InDE and WtDE have the FP16 format, multiplier circuit 120A is configured to generate each of products P[0]-P[N] having a total of 23 bits based on each of signed mantissas InS/InM and WtS/WtM and reformatted mantissas InTC and WtTC having a total of 12 bits. Embodiments in which multiplier circuit 120A is configured to generate each of products P[0]-P[N] having other total bit numbers based on each of signed mantissas InS/InM and WtS/WtM and reformatted mantissas InTC and WtTC having other total bit numbers are within the scope of the present disclosure.

Multiplier circuit 120A is thereby configured to, in operation, perform multiplication and reformatting operations on sign and mantissa bits of input data elements InDE and weight data elements WtDE so as to generate two's complement products P[0]-P[N].

Multiplier circuit 120A is configured to output products P[0]-P[N] to shifting circuit 150 on a data bus (not labeled), as further discussed below.

Summing circuit 130 includes one or more data registers (not labeled) configured to receive the instances of exponents InE and WtE corresponding to the number of data elements of data elements InDE and WtDE discussed above with respect to multiplier circuit 120.

Summing circuit 130 includes one or more logic gates A1 configured to, in operation, add each instance of exponent InE to each instance of exponent WtE. In various embodiments, the one or more logic gates A1 include one or more full adder gates, half adder gates, ripple-carry adder circuits, carry-save adder circuits, carry-select adder circuits, carry-look-ahead adder circuits, or other circuits suitable for performing some or all of an addition operation. The one or more logic gates A1 are configured to generate sums S[0]-S[N] as data elements having a total number of bits equal to the number of bits of each of exponents InE and WtE plus one.

Summing circuit 130 is configured to, in operation, generate sums S[0]-S[N] having the total number N+1 and an ordering of data elements corresponding to the total number N+1 and ordering of the data elements of products P[0]-P[N] discussed above with respect to multiplier circuit 120. Accordingly, for a total of N combinations of data elements InDE and WtDE, each nth combination corresponds to both the nth sum S[n] of sums S [0]-S [N] and the nth product P[n] of products P[0]-P[N].

In some embodiments, e.g., those in which data elements InDE and WtDE have the BF16 format, summing circuit 130 is configured to generate each of sums S[0]-S[N] having a total of nine bits based on each of exponents InE and WtE having a total of eight bits. In some embodiments, e.g., those in which data elements InDE and WtDE have the FP16 format, summing circuit 130 is configured to generate each of sums S[0]-S[N] having a total of six bits based on each of exponents InE and WtE having a total of five bits. Summing circuit 130 being configured to generate each of sums S[0]-S[N] having other total bit numbers based on each of exponents InE and WtE having other total bit numbers is within the scope of the present disclosure.

Summing circuit 130 is configured to output sums S[0]-S[N] to difference circuit 140 on a data bus (not labeled).

Difference circuit 140 is an electronic circuit, e.g., an IC, including one or more logic gates L1 and one or more logic gates B1, each configured to receive sums S[0]-S[N] from summing circuit 130.

The one or more logic gates L1 are configured to, in operation, generate a maximum sum MaxExp as a data element having a value equal to a maximum value of the data elements of sums S[0]-S[N] and having a number of bits equal to those of the data elements of sums S[0]-S[N]. The one or more logic gates L1 are configured to output maximum sum MaxExp to the one or more logic gates B1 and to converter circuit 180, as discussed below.

The one or more logic gates B1 are configured to, in operation, generate differences D[0]-D[N] by subtracting each data element of sums S[0]-S[N] from maximum sum MaxExp. Differences D[0]-D[N] thereby have the total number N+1 and ordering of data elements corresponding to that of sums S[0]-S[N] and products P[0]-P[N] discussed above.

In the embodiment depicted in FIG. 1A, the one or more logic gates B1 are configured to output differences D[0]-D[N] to each of multiplier circuit 120A and shifting circuit 150 on a data bus (not labeled).

In the embodiment depicted in FIG. 1A, multiplier circuit 120A is configured to, in operation, receive differences D[0]-D[N], compare each instance D[n] of differences D[0]-D[N] to the first difference threshold (not shown in FIG. 1A), and generate the corresponding instance P[n] of products P[0]-P[N] by performing the multiplying operation only if the difference is less than the first difference threshold.

For a given instance D[n] of differences D[0]-D[N], the difference D[n] less than the first difference threshold represents the corresponding instance S[n] of sums S[0]-S[N] having a value greater than maximum sum MaxExp minus the first difference threshold. As discussed below with respect to shifting circuit 150, only instances P[n] of products P[0]-P[N] corresponding to such instances S[n] are capable of affecting a subsequent summing operation performed by adder tree 160. Accordingly, by performing the multiplying operation only if the difference is less than the first difference threshold, less power is consumed compared to embodiments in which the multiplication operation is always performed.

In some embodiments, the one or more logic gates B1 are not configured to output differences D[0]-D[N] to multiplier circuit 120A, and multiplier circuit 120A is configured to generate each instance P[n] of products P[0]-P[N] by always performing the multiplying operation. In such embodiments, multiplier circuit 120A is less complex compared to embodiments in which the multiplying operation is performed only if the difference D[n] is less than the first difference threshold.

Shifting circuit 150 is an electronic circuit, e.g., an IC, including one or more registers and/or logic gates configured to perform a shifting operation on each instance P[n] of products P[0]-P[N] based on the value of the corresponding instance D[n] of differences D[0]-D[N].

Each instance P[n] of products P[0]-P[N] is based on the sign and mantissa of a corresponding combination of data elements InDE and WtDE, and each instance D[n] of differences D[0]-D[N] is based on the sum of the exponents of the same combination. Shifting circuit 150 is configured to, in operation, right-shift each instance P[n] of products P[0]-P[N] by an amount equal to the corresponding difference D[n], thereby generating shifted products SP[0]-SP[N] in which sign and mantissa bits are aligned in accordance with the summed exponents used to generate differences D[0]-D[N]. Based on this alignment, shifting circuit 150 is configured to generate each instance SP[n] of shifted products SP[0]-SP[N] having a same exponent using maximum sum MaxExp as a baseline.

To compensate for the right-shifting operation, shifting circuit 150 is configured to add instances of the sign bit (zero or one) of each product P[n] as the leftmost bits of the corresponding shifted product SP[n]. The number of added instances of the sign bit is equal to the amount of the right shift as determined by the corresponding difference D[n].

In some embodiments, shifting circuit 150 is configured to generate shifted products SP[0]-SP[N] having a number of bits greater than that of products P[0]-P[N]. In such embodiments, shifting circuit 150 is configured to add trailing zero bits as the rightmost bits of shifted products SP[0]-SP[N], as needed. A difference between the numbers of bits of shifted products SP[0]-SP[N] and products P[0]-P[N] defines a second difference threshold such that a difference D[n] equal to or less than the second difference threshold corresponds to a case in which one or more zero bits are added, and a difference D[n] greater than the second difference threshold corresponds to a case in which no zero bits are added.

As the difference between the numbers of bits of shifted products SP[0]-SP[N] and products P[0]-P[N] increases, the resolution of shifted products SP[0]-SP[N] increases and the complexity of shifting circuit 150 increases. In some embodiments, the difference between the numbers of bits of shifted products SP[0]-SP[N] and products P[0]-P[N] has a value ranging from two to eight. In some embodiments, the difference between the numbers of bits of shifted products SP[0]-SP[N] and products P[0]-P[N] is equal to four.

The numbers of mantissa bits of each data element of shifted products SP[0]-SP[N] corresponds to the first difference threshold discussed above with respect to multiplier circuit 120 and difference circuit 140. A difference D[n] less than the first difference threshold corresponds to a case in which at least one bit of the corresponding product P[n] is included in the corresponding shifted product SP[n], and a difference D[n] greater than or equal to the first difference threshold corresponds to a case in which no bits of the corresponding product P[n] are capable of being included in the corresponding shifted product SP[n]. Accordingly, shifting circuit 150 is configured to, in operation, generate each shifted product SP[n] from the corresponding product P[n] based on the corresponding difference D[n] being less than the first difference threshold, and generate each shifted product SP[n] as a zero-value data element (all zero bits) based on the corresponding difference D[n] being greater than or equal to the first difference threshold.

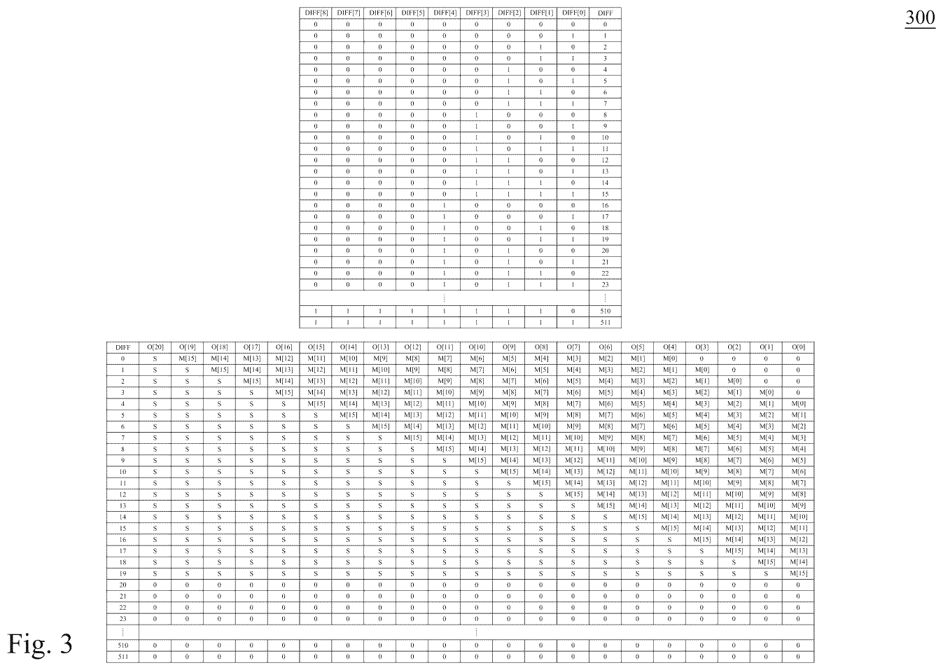

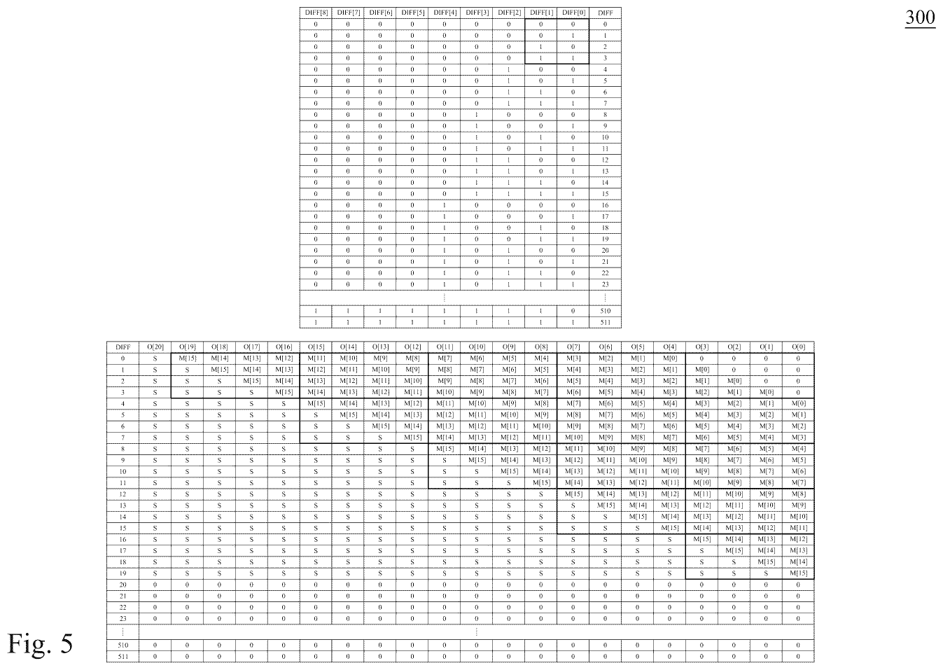

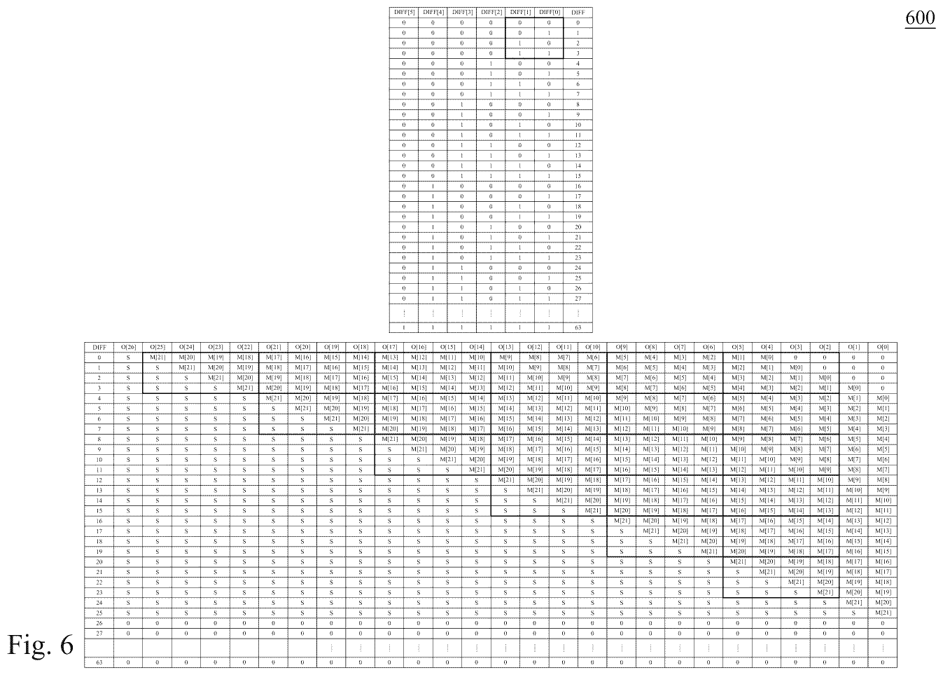

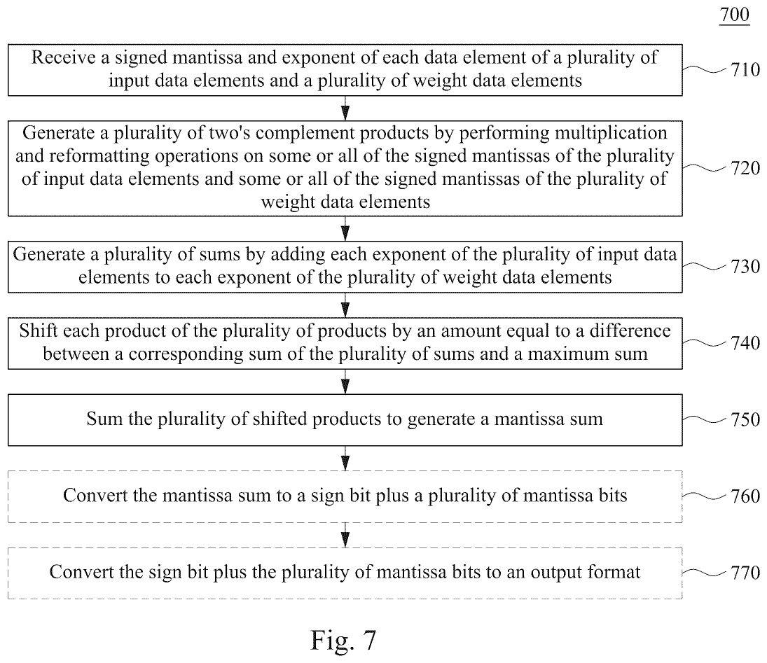

In some embodiments, e.g., those in which data elements InDE and WtDE have the BF16 format, shifting circuit 150 is configured to generate each of shifted products SP[0]-SP[N] having a total of 21 bits based on each of products P[0]-P[N] having a total of 17 bits, as discussed below with respect to FIGS. 3 and 5. In some embodiments, e.g., those in which data elements InDE and WtDE have the FP16 format, shifting circuit 150 is configured to generate each of shifted products SP[0]-SP[N] having a total of 27 bits based on each of products P[0]-P[N] having a total of 23 bits, as discussed below with respect to FIGS. 6 and 7. Shifting circuit 150 being configured to generate each of shifted products SP[0]-SP[N] having other total bit numbers based on each of products P[0]-P[N] having other total bit numbers is within the scope of the present disclosure.

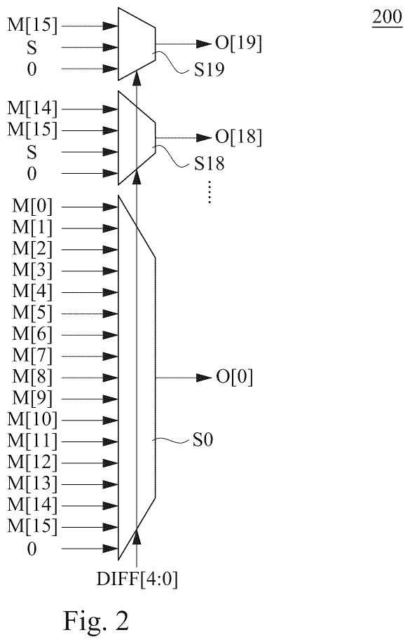

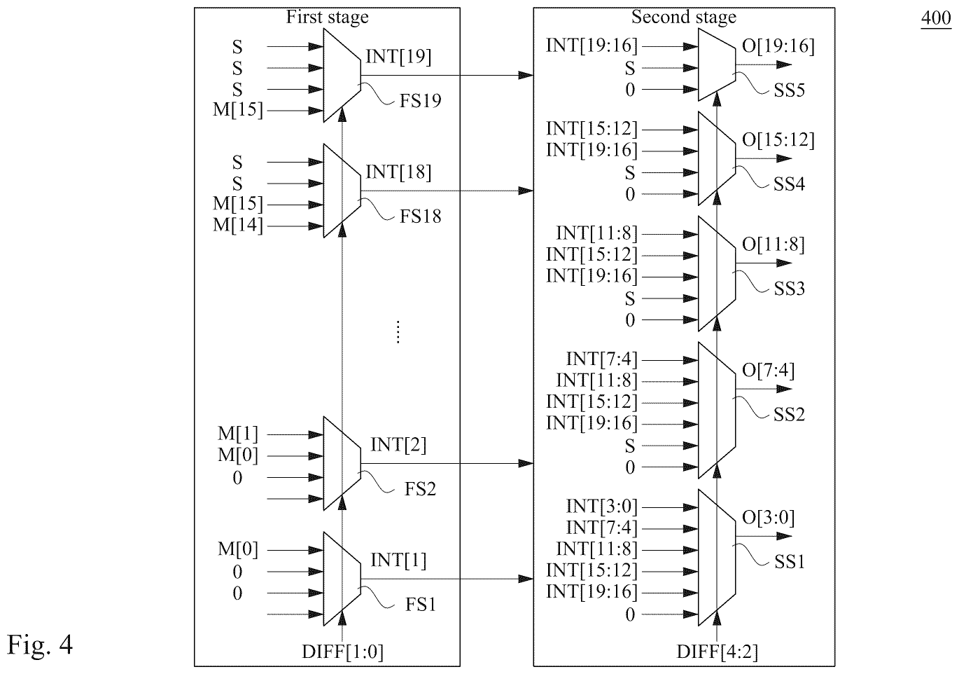

In some embodiments, shifting circuit 150 includes shifting circuit 200 discussed below with respect to FIG. 2. In some embodiments, shifting circuit 150 includes shifting circuit 400 discussed below with respect to FIG. 4.

Based on products P[0]-P[N] having a two's complement format, shifting circuit 150 is configured to generate shifted products SP[0]-SP[N] having a two's complement format.

Shifting circuit 150 is configured to output shifted products SP[0]-SP[N] to adder tree 160 on a data bus (not labeled).

Adder tree 160 is an electronic circuit, e.g., an IC, including multiple layers of one or more logic gates (not shown), e.g., as discussed above with respect to one or more logic gates A1, in which a first layer is configured to receive shifted products SP[0]-SP[N], and a last layer is configured to generate a sum PSTC as a data element corresponding to a sum of shifted products SP[0]-SP[N]. In some embodiments, each of one or more successive layers between the first and last layers is configured to receive a first number of sum data elements generated by a preceding layer, and generate a second number of sum data elements based on the first number of sum data elements, the second number being half the first number. Thus, a total number of layers includes the first and last layers and each successive layer, if present.

Adder tree 160 is configured to, in operation, generate sum PSTC, also referred to as partial sum PSTC or mantissa sum PSTC in some embodiments, having a total number of bits corresponding to the number of bits and number of data elements of shifted products SP[0]-SP[N]. In some embodiments, the number of bits of sum PSTC is equal to the number of bits of shifted products SP[0]-SP[N] plus a number of bits capable of representing the number of data elements of shifted products SP[0]-SP[N]. In some embodiments, the number of bits of sum PSTC is equal to the number of bits of shifted products SP[0]-SP[N] plus four bits capable of representing 16 data elements of shifted products SP[0]-SP[N].

In some embodiments, e.g., those in which data elements InDE and WtDE have the BF16 format, adder tree 160 is configured to generate sum PSTC having a total of 25 bits based on each of shifted products SP[0]-SP[N] having a total of 21 bits. In some embodiments, e.g., those in which data elements InDE and WtDE have the FP16 format, adder tree 160 is configured to generate sum PSTC having a total of 31 bits based on each of shifted products SP[0]-SP[N] having a total of 27 bits. Adder tree 160 being configured to generate sum PSTC based on each of shifted products SP[0]-SP[N] having other total bit numbers is within the scope of the present disclosure.

Based on shifted products SP[0]-SP[N] having a two's complement format, adder tree 160 is configured to generate sum PSTC having a two's complement format.

In the embodiment depicted in FIG. 1A, adder tree 160 is configured to output sum PSTC to converter 170 on a data bus (not labeled). In some embodiments, adder tree 160 is configured to output sum PSTC to a circuit (not shown) external to circuit 100.

Converter 170 is an electronic circuit, e.g., an IC, including logic circuitry configured to, in operation, receive sum PSTC from adder tree 160, and convert sum PSTC from two's complement to a sum PSSM having a sign plus mantissa format. Converter 170 is configured to generate sum PSSM having a same number of bits as that of sum PSTC.

In the embodiment depicted in FIG. 1A, converter 170 is configured to output sum PSSM to converter 180 on a data bus (not labeled). In some embodiments, converter 170 is configured to output sum PSSM to a circuit (not shown) external to circuit 100. In some embodiments, converter 170 is configured to output sum PSSM to adder 830 discussed below with respect to FIG. 8.

Converter 180 is an electronic circuit, e.g., an IC, including logic circuitry configured to, in operation, receive sum PSSM from converter 170 and maximum sum MaxExp from difference circuit 140, and convert sum PSSM from the sign plus mantissa format to a sum PS having an output format based on sum PSSM and MaxExp and different from the sign plus mantissa format, e.g., a floating point format as discussed above. In some embodiments, converter 180 is configured to generate sum PS configured to be compatible with a circuit (not shown) external to circuit 100.

In the embodiment depicted in FIG. 1A, converter 180 is configured to output sum PS to a circuit (not shown) external to circuit 100, e.g., a memory array or other instance of circuit 100 as part of a CNN. In some embodiments, converter 180 is configured to output sum PS to adder 830 discussed below with respect to FIG. 8.

In the embodiment depicted in FIG. 1B, circuit 100 is configured as discussed above with respect to FIG. 1A with the exception of including multiplier circuit 120B instead of multiplier circuit 120A.

Multiplier circuit 120B is an electronic circuit configured to receive sign bits InS and WtS and mantissas InM and WtM, and generate products P[0]-P[N] in accordance with each of the embodiments discussed above with respect to multiplier circuit 120A, e.g., as related to various data element formats and conditionally performing multiplication operations based on differences D[0]-D[N].

Multiplier circuit 120B includes one or more logic gates M1 discussed above with respect to multiplier circuit 120A, and also includes an exclusive OR (XOR) gate X1.

XOR gate X1 includes two input terminals configured to receive sign bits InS and WtS, and is configured to, in operation, generate a sign bit SB on an output terminal based on the exclusive OR logic of Table 1.

TABLE 1

| InS | WtS | SB |
|---|---|---|
| 0 | 0 | 0 |
| 0 | 1 | 1 |
| 1 | 0 | 1 |
| 1 | 1 | 0 |

As depicted in FIG. 1B, multiplier circuit 120B includes one or more logic gates M1 configured to receive mantissas InM and WtM and generate a mantissa product MP by performing a multiplication operation on mantissas InM and WtM.

Multiplier circuit 120B includes one or more logic circuits configured to, in operation, convert sign bit SB combined with mantissa product MP into two's complement format as a given product P[n] of products P[0]-P[N].

Multiplier circuit 120B is thereby configured to, in operation, perform multiplication and reformatting operations on sign and mantissa bits of input data elements InDE and weight data elements WtDE so as to generate two's complement products P[0]-P[N]. Compared to multiplier circuit 120A, multiplier circuit 120B is capable of performing the multiplication and reformatting operations at a higher speed, using less power, and/or by using a smaller area.

In each of the embodiments discussed above, circuit 100 is thereby configured to perform data computations by separating sign and mantissa bits from exponent bits of input data elements InDE and weight data elements WtDE. Multiplier circuit 120A or 120B performs multiplication and reformatting operations on the sign and mantissa bits of the input and weight data to generate two's complement products P[0]-P[N], and summing circuit 130 adds the exponents of the input data to those of the weight data to generate sums S[0]-S[N]. Shifting circuit 150 shifts the products based on differences between sums S[0]-S[N] and maximum sum MaxExp, and adder tree 160 adds shifted products SP[0]-SP[N] together to produce partial sum PSTC. Circuit 100 is thereby configured to perform floating point partial sum computations using less time, area, and power than in other approaches, and without quantization errors present in some approaches in which floating point data are converted to fixed point data.

FIG. 2 is a schematic diagram of shifting circuit 200, in accordance with some embodiments. Shifting circuit 200 is usable as some or all of shifting circuit 150 discussed above with respect to FIG. 1A. In the embodiment depicted in FIG. 2, shifting circuit 200 corresponds to data elements InDE and WtDE having the BF16 format and shifted products SP[0]-SP[N] having a total of 21 bits.

In the embodiment depicted in FIG. 2, shifting circuit 200 includes selection circuits S0-S19, of which selection circuits S0, S18, and S19 are depicted in FIG. 2. Each of selection circuits S0-S19 is configured to receive signals DIFF[4:0] representative of difference D[n] discussed above with respect to FIG. 1A.

Each of selection circuits S0-S19 is configured to receive some or all of signals M[0]-M[15] corresponding to the 16 mantissa bits of a product P[n] of products P[0]-P[N] each having a total of 17 bits including a sign bit S. Each of selection circuits S0-S19 is configured to also receive a zero bit 0, and each of selection circuits S1-S19 is configured to also receive sign bit S of product P[n].

Selection circuit S0 is configured to receive all of signals M[0]-M[15], and selection circuit S19 is configured to receive only signal M[15]. Each of selection circuits S1-S18 is configured to receive a subset of signals M[0]-M[15], the subsets decreasing in number by one with each selection circuit number increase. The signals having the highest index numbers are included in each subset, as illustrated by selection circuit S18 being configured to receive signals M[14] and M[15].

Based on signals M[0]-M[15], zero bit 0, and sign bit S, selection circuits S0-S19 are configured to, in operation, generate respective signals O[0]-O[19] corresponding to the mantissa bits of shifted product SP[n] corresponding to product P[n]. Responsive to signals DIFF[4:0], selection circuit S0 is configured to generate signal O[0] by selecting one of signals M[0]-M[15] or zero bit 0, selection circuit S19 is configured to generate signal O[19] by selecting one of signal M[15], zero bit 0, or sign bit S, and each of selection circuits S1-S18 is configured to generate a corresponding one of signals O[1]-O[18] by selecting one of the corresponding subset of signals M[1]-M[15], zero bit 0, or sign bit S.

In the embodiment depicted in FIG. 2, shifted product SP[n] having 20 mantissa bits corresponds to the first difference threshold equal to 20, as discussed above with respect to shifting circuit 150. Accordingly, selection circuits S0-S19 and signals DIFF[4:0] are configured to generate each of signals O[0]-O[19] as zero bit 0 in response to difference D[n] having a value greater than or equal to 20.

The number of selection circuits and signal configurations depicted in FIG. 2 are non-limiting examples provided for the purpose of illustration. In some embodiments, shifting circuit 200 includes fewer or greater numbers of selection circuits similarly configured to generate a shifted signal from a signal corresponding to a format other than the BF16 format, as discussed above with respect to FIG. 1A.

By the configuration discussed above, shifting circuit 200 is capable of executing the operations discussed above with respect to shifting circuit 150 and FIG. 1 such that a circuit including shifting circuit 200 is capable of realizing the benefits discussed above with respect to data computation circuit 100.

FIG. 3 is a diagram of data elements 300 of a shifting circuit, e.g., shifting circuit 200, in accordance with some embodiments. Data elements 300 correspond to an embodiment in which data elements InDE and WtDE have the BF16 format and shifted products SP[0]-SP[N] have 21 bits, as discussed above with respect to FIGS. 1A and 2.

Data elements 300 include signals DIFF[8:0] corresponding to difference D[n] having nine bits, signal values DIFF, and output signals O[0]-O[20] corresponding to shifted product SP[n] for each signal value DIFF. Output signals O[0]-O[19] correspond to the outputs of selection circuits S0-S19 depicted in FIG. 2, and output signal O[20] corresponds to sign bit S of product P[n].

In the embodiment depicted in FIG. 3, the second difference threshold is four, and one or more of signals O[0]-O[3] include zero bit 0 in accordance with signal value DIFF less than or equal to four. For signal value DIFF greater than or equal to the second difference threshold of 20, each of signals O[0]-O[20] includes zero bit 0. For signal value DIFF less than the second difference threshold of 20, signals O[0]-O[20] include signals M[0]-M[15] right-shifted by signal value DIFF along with leading sign bits S. The number of sign bits S corresponds to sign bit S of product P[n] plus a number of added sign bits S equal to signal value DIFF.

FIG. 4 is a schematic diagram of shifting circuit 400, in accordance with some embodiments. Shifting circuit 400 is usable as some or all of shifting circuit 150 discussed above with respect to FIG. 1A. In the embodiment depicted in FIG. 4, shifting circuit 400 corresponds to data elements InDE and WtDE having the BF16 format and shifted products SP[0]-SP[N] having a total of 21 bits.

Shifting circuit 400 is functionally equivalent to shifting circuit 200 discussed above and has a different configuration as discussed below. FIG. 4 depicts signals M[0]-M[15], O[0]-[19], and DIFF[4:0], sign bit S, and zero bit 0, each discussed above with respect to FIGS. 2 and 3.

Shifting circuit 400 includes a first stage and a second stage. In the embodiment depicted in FIG. 4, the first stage includes selection circuits FS1-FS19 (FS1, FS2, FS18, and FS19 depicted in FIG. 4), each configured to receive signals DIFF[1:0], and the second stage includes selection circuits SS1-SS5, each configured to receive signals DIFF[4:2].

Each of selection circuits FS1-FS19 is configured to receive a subset of signals M[0]-M[15] and either sign bit S or zero bit 0. Each of selection circuits FS1-FS19 includes a total of four inputs configured to receive the subsets having numbers ranging from one to four, and in some cases, one or more instances of sign bit S or zero bit 0, as depicted in FIG. 4. In operation, in response to signals DIFF[1:0], each of selection circuits FS1-FS19 is thereby configured to output a predetermined one of signals M[0]-M[15], sign bit S, or zero bit 0 as a corresponding one of signals INT[1]-INT[19], also referred to as intermediate signals or data elements INT[1]-INT[19] in some embodiments. In addition to signals INT[1]-INT[19], intermediate signals INT[0]-INT[19] include a signal INT[0] having zero bit 0.

Each of selection circuits SS1-SS5 is configured to receive a subset of intermediate signals INT[0]-INT[19] and zero bit 0, and each of selection circuits SS2-SS5 is configured to receive sign bit S, as depicted in FIG. 4. In operation, in response to signals DIFF[4:2], each of selection circuits SS1-SS5 is configured to output a respective four-bit portion of signal O[0]-O[19]: O[3:0], O[7:4], O[11:8], O[15:12], or O[19:16].

The four-bit portions of signal O[0]-O[19] correspond to data patterns illustrated in FIG. 5, a diagram of data elements 300 discussed above with respect to FIG. 3. As indicated by a first highlighted portion of data elements 300 depicted in FIG. 5, signals DIFF[1:0] correspond to a range of four possible values of signal value DIFF, and to four possible combinations of intermediate signals INT[0]-INT[19] depicted in FIG. 4.

The additional highlighted portions correspond to the five, four-bit portions of signal O[0]-O[19] output by selection circuits SS1-SS5 in response to the four combinations of intermediate signals INT[0]-INT[19] and to the combinations of signals DIFF[4:2]. The highlighted portions are blocks of four rows each based on intermediate signals INT[0]-INT[19] and right-shifted within signal O[0]-O[19] in accordance with signals DIFF[4:2]. Accordingly, blocks having identical bit configurations align along descending diagonal lines.

As depicted in FIG. 4 and illustrated in FIG. 5, shifting circuit 400 includes the first stage configured to generate intermediate signals INT[0]-INT[19] having four combinations correspond to the two LSB, DIFF[1:0], and the second stage configured to generate from one to five blocks of signals O[0]-O[19] based on the four combinations and right-shifted in accordance with a portion of the remaining bits, DIFF[4:2].

In some embodiments, shifting circuit 400 includes first and second stages configured (not shown) in accordance with data elements InDE and WtDE having the FP16 format. FIG. 6 is a diagram of data elements 600 of a shifting circuit, e.g., shifting circuit 200 or 400, in accordance with some embodiments in which data elements InDE and WtDE have the FP16 format and shifted products SP[0]-SP[N] have 27 bits, as discussed above with respect to FIGS. 1A and 2.

Data elements 600 include signals DIFF[5:0] corresponding to difference D[n] having six bits, signal values DIFF, and output signals O[0]-O[26] corresponding to shifted product SP[n] for each signal value DIFF. Output signals O[0]-O[25] correspond to the outputs of shifting circuit 200 or 400, and output signal O[26] corresponds to sign bit S of product P[n].

In the embodiment depicted in FIG. 6, the second difference threshold is four, and one or more of signals O[0]-O[3] include zero bit 0 in accordance with signal value DIFF less than or equal to four. For signal value DIFF greater than or equal to the second difference threshold of 26, each of signals O[0]-O[26] includes zero bit 0. For signal value DIFF less than the second difference threshold of 26, signals O[0]-O[25] include signals M[0]-M[21] right-shifted by signal value DIFF along with leading sign bits S. The number of sign bits S corresponds to sign bit S of product P[n] plus a number of added sign bits S equal to signal value DIFF.

As in FIG. 5, data elements 600 depicted in FIG. 6 include a first highlighted portion corresponding to the four combinations of DIFF[1:0], and additional highlighted portions corresponding to six, four-bit portions of signals O[2]-O[25] output by the second stage of shifting circuit 400 in response to four combinations of intermediate signals (not shown) and to the combinations of signals DIFF[4:2]. The highlighted portions are blocks of four rows each based on the intermediate signals and right-shifted within signals O[2]-O[25] in accordance with signals DIFF[4:2]. Data elements 600 also include signals O[0] and O[1] output by the second stage of shifting circuit 400.

In some embodiments, data elements 600 depicted in FIG. 6 thereby correspond to an embodiment of shifting circuit 200 including one or more selection circuits in addition to selection circuits S0-S19 depicted in FIG. 2.

In some embodiments, data elements 600 depicted in FIG. 6 thereby correspond to an embodiment of shifting circuit 400 including one or more selection circuits in the first stage in addition to selection circuits FS1-FS19, and one or more selection circuits in the second stage in addition to selection circuits SS1-SS5, as depicted in FIG. 2.

In some embodiments, shifting circuit 400 includes fewer or greater numbers of selection circuits similarly configured to generate a shifted signal from a signal corresponding to a format other than the BF16 or FP16 formats, as discussed above with respect to FIG. 1A.

By the configuration discussed above, shifting circuit 400 is capable of executing the operations discussed above with respect to shifting circuit 150 and FIG. 1A such that a circuit including shifting circuit 400 is capable of realizing the benefits discussed above with respect to data computation circuit 100. By including the first and second stage configuration discussed above, shifting circuit 400 is further capable of having less complex signal routing and up to 50% smaller area than approaches that do not include a first and second stage configuration, e.g., shifting circuit 200 discussed above.

FIG. 7 is a flowchart of method 700 of operating a circuit, in accordance with some embodiments. Method 700 is usable with a data computation circuit, e.g., data computation circuit 100 discussed above with respect to FIGS. 1A and 1B.

The sequence in which the operations of method 700 are depicted in FIG. 7 is for illustration only; the operations of method 700 are capable of being executed in sequences that differ from that depicted in FIG. 7. In some embodiments, operations in addition to those depicted in FIG. 7 are performed before, between, during, and/or after the operations depicted in FIG. 7. In some embodiments, the operations of method 700 are a subset of a method of performing a CIM operation, e.g., as part of a CNN operation.

At operation 710, a signed mantissa and exponent of each data element of a plurality of input data elements and a plurality of weight data elements are received. Receiving the signed mantissa includes receiving a sign bit and mantissa bits at a multiplier circuit, e.g., multiplier circuit 120A or 120B, and receiving the exponent includes receiving the exponent at a summing circuit, e.g., summing circuit 130, each discussed above with respect to FIGS. 1A and 1B.

In some embodiments, receiving the signed mantissa and exponent of each data element of the plurality of input data elements and the plurality of weight data elements includes receiving signed mantissas InS/InM and WtS/WtM and exponents InE and WtE of each data element of data elements InDE and WtDE discussed above with respect to FIGS. 1A and 1B.

In some embodiments, receiving the signed mantissa and exponent of each data element includes receiving each data element of the plurality of input data elements and the plurality of weight data elements having either the BF16 format or the FP16 format as discussed above with respect to FIGS. 1A-6.

In some embodiments, the circuit includes a memory array, e.g., memory array 110 discussed above with respect to FIG. 1A, and receiving the signed mantissa and exponent includes receiving each data element from the plurality of input data elements and the plurality of weight data elements stored in the memory array.

At operation 720, each signed mantissa is reformatted to two's complement. Reformatting each signed mantissa to two's complement includes using the multiplier circuit.

In some embodiments, reformatting each signed mantissa to two's complement includes reformatting signed mantissa InS/InM to reformatted mantissa InTC and reformatting signed mantissa WtS/WtM to reformatted mantissa WtTC, as discussed above with respect to FIG. 1.

At operation 720, a plurality of two's complement products is generated by performing multiplication and reformatting operations on some or all of the signed mantissas of the plurality of input data elements and some or all of the signed mantissas of the plurality of weight data elements. Generating the plurality of two's complement products by performing the multiplication and reformatting operations includes using the multiplier circuit, e.g., multiplier circuit 120A discussed above with respect to FIG. 1A or multiplier circuit 120B discussed above with respect to FIG. 1B.

In some embodiments, generating the plurality of products includes reformatting each signed mantissa to two's complement and multiplying some or all of the reformatted mantissas of the plurality of input data elements with some or all of the reformatted mantissas of the plurality of weight data elements. In some embodiments, reformatting each signed mantissa to two's complement and multiplying some or all of the reformatted mantissas of the plurality of input data elements with some or all of the reformatted mantissas of the plurality of weight data elements includes reformatting signed mantissa InS/InM to reformatted mantissa InTC and reformatting signed mantissa WtS/WtM to reformatted mantissa WtTC, and generating products P[0]-P[N] by multiplying reformatted mantissas InTC with reformatted mantissas WtTC, as discussed above with respect to FIG. 1A.

In some embodiments, generating the plurality of products includes generating a plurality of sign bits by performing an exclusive OR operation on sign bits of the signed mantissas of the some or all of the pluralities of input and weight data elements, generating a corresponding plurality of mantissa products by multiplying mantissa bits of the signed mantissas of the some or all of the plurality of input data elements with mantissa bits of the signed mantissas of the some or all of the plurality of weight data elements, and reformatting the pluralities of sign bits and mantissa products to two's complement. In some embodiments, generating the plurality of products includes generating plurality of sign bits SB by performing the exclusive OR operation sign bits InS and WtS, generating corresponding plurality of mantissa products MP by multiplying mantissas InM of the some or all of input data elements InDE with mantissas WtM of the some or all of weight data elements WtDE, and reformatting sign bits SB and mantissa products MP to two's complement, as discussed above with respect to FIG. 1B.

In some embodiments, generating the plurality of products includes, for each difference between the corresponding sum of the plurality of sums and a maximum sum, e.g., difference D[n] based on maximum sum MaxExp discussed above with respect to FIG. 1A, performing the multiplication and reformatting operations on the corresponding input and weight data elements only if the difference is less than a difference threshold, e.g., the first difference threshold discussed above with respect to FIGS. 1A-6.

At operation 730, a plurality of sums is generated by adding each exponent of the plurality of input data elements to each exponent of the plurality of weight data elements. Generating the plurality of sums by adding each exponent of the plurality of input data elements to each exponent of the plurality of weight data elements includes using a summing circuit, e.g., summing circuit 130 including one or more logic gates A1 discussed above with respect to FIG. 1A.

Generating the plurality of sums by adding each exponent of the plurality of input data elements to each exponent of the plurality of weight data elements includes generating the plurality of sums having a total number and ordering of data elements corresponding to the total number and ordering of the data elements of the plurality of products generated in operation 720.

In some embodiments, generating the plurality of sums by adding each exponent of the plurality of input data elements to each exponent of the plurality of weight data elements includes generating sums S[0]-S[N] by adding exponents InE to WtE as discussed above with respect to FIG. 1A.

In some embodiments, generating the plurality of sums includes using a difference circuit to determine a maximum sum of the plurality of sums and generate a plurality of differences by subtracting each sum of the plurality of sums from the maximum sum. In some embodiments, using the difference circuit to determine the maximum sum of the plurality of sums and generate the plurality of differences by subtracting each sum of the plurality of sums from the maximum sum includes using difference circuit 140 to determine maximum sum MaxExp and generate differences D[0]-D[N] by subtracting sums S[0]-S[N] from MaxExp, as discussed above with respect to FIG. 1A.

At operation 740, each product of the plurality of products is shifted by an amount equal to a difference between a corresponding sum of the plurality of sums and the maximum sum. Shifting each product of the plurality of products includes generating a plurality of shifted products using a shifting circuit, e.g., generating shifted products SP[0]-SP[N] using shifting circuit 150 discussed above with respect to FIG. 1A or shifting circuit 200 or 400 discussed above with respect to FIGS. 2-6.

In some embodiments, shifting each product of the plurality of products by the amount equal to the difference between the corresponding sum of the plurality of sums and the maximum sum includes shifting each of products P[0]-P[N] by the amount equal to the corresponding difference D[0]-D[N].

In some embodiments, shifting each product of the plurality of products includes generating an intermediate data element from the product based on the two least significant bits of the corresponding difference, and generating the corresponding shifted product from the intermediate data element based on the other bits of the corresponding difference. In some embodiments, generating the intermediate data element includes generating signal INT[0]-INT[19] using the first stage of shifting circuit 400, and generating the corresponding shifted product includes generating signal O[0]-O[19] using the second stage as discussed above with respect to FIGS. 4-6.

In some embodiments, shifting each product of the plurality of products by the amount equal to the difference between the corresponding sum of the plurality of sums and the maximum sum includes generating a zero-value data element based on the difference being greater than or equal to the difference threshold, e.g., the first difference threshold discussed above with respect to FIGS. 1A-6.

In some embodiments, shifting each product of the plurality of products by the amount equal to the difference between the corresponding sum of the plurality of sums and the maximum sum includes right-shifting the product by the amount, adding a number of leading sign bits to the shifted product, the number being equal to the amount, and adding one or more trailing zero bits corresponding to the amount being less than a difference threshold, e.g., adding sign bits S and zero bits 0 based on the second difference threshold as discussed above with respect to FIGS. 1A-6.

At operation 750, the plurality of shifted products are summed to generate a mantissa sum. Summing the plurality of shifted products to generate the mantissa sum includes using an adder tree, e.g., adder tree 160 discussed above with respect to FIG. 1A.

In some embodiments, summing the plurality of shifted products to generate the mantissa sum includes summing shifted products SP[0]-SP[N] to generate sum PSTC as discussed above with respect to FIG. 1A.

At operation 760, in some embodiments, the mantissa sum is converted to a sign bit plus a plurality of mantissa bits. Converting the mantissa sum to the sign bit plus the plurality of mantissa bits includes using a converter, e.g., converter 170 discussed above with respect to FIG. 1A.

In some embodiments, converting the mantissa sum to the sign bit plus the plurality of mantissa bits includes converting sum PSTC to sum PSSM as discussed above with respect to FIG. 1A.

At operation 770, in some embodiments, the sign bit plus the plurality of mantissa bits are converted to an output format. Converting the sign bit plus the plurality of mantissa bits to the output format includes using a converter, e.g., converter 180 discussed above with respect to FIG. 1A.

In some embodiments, converting the sign bit plus the plurality of mantissa bits to the output format includes converting sum PS SM to sum PS as discussed above with respect to FIG. 1A.

In some embodiments, converting the sign bit plus the plurality of mantissa bits to the output format includes outputting a sum having the output format from the circuit to an external circuit, e.g., a memory array as part of a CNN operation.

By executing some or all of the operations of method 700, data computations are performed by separating sign and mantissa bits from exponent bits of input and weight data elements, performing multiplication and reformatting operations on sign and mantissa bits of the input data and weight data to generate two's complement products, adding the exponents of the input data to those of the weight data to generate sums, shifting the products based on differences between the sums and a maximum sum, and adding the shifted products together to produce a partial sum, thereby achieving some or all of the benefits discussed above with respect to data computation circuit 100 and shifting circuits 200 and 400.

FIG. 8 is a schematic diagram of a CIM circuit 800, in accordance with some embodiments. In the embodiment depicted in FIG. 8, CIM circuit 800, also referred to as circuit 800 or memory circuit 800 in some embodiments, includes a memory array 810, a MAC unit 820, adder 830, and buffer 840.

In the embodiment depicted in FIG. 8, an output port of memory array 810 is coupled to an input port of MAC unit 820, an output port of MAC unit 820 is coupled to an input port of adder 830, an output port of adder 830 is coupled to an input port of buffer 840, and an output port of buffer 840 is coupled to an input port of adder 830. The output port of buffer 840 is also coupled to an external circuit (not shown), e.g., a memory array.

The embodiment depicted in FIG. 8 is a non-limiting example provided for the purpose of illustration. In some embodiments, circuit 800 has a configuration other than that depicted in FIG. 8 whereby the benefits discussed below are capable of being realized. In some embodiments, circuit 800 does not include memory array 810, and the input port of MAC unit 820 is coupled to a circuit, e.g., a memory array, external to circuit 800. In some embodiments, the input port of MAC unit is coupled to one of adder tree 160, converter 170, or converter 180 discussed above with respect to FIG. 1A.

In some embodiments, circuit 800 includes circuit elements in addition to those depicted in FIG. 8 and discussed below, e.g., a control circuit or additional instances of the depicted circuit elements. In some embodiments, the elements depicted in FIG. 8 are a portion of a memory circuit including multiple instances of memory array 810, MAC unit 820, adder 830, and buffer 840.

In some embodiments, circuit 800 is included in a circuit including elements configured to perform a series of in-memory computations, e.g., a CNN in which multiple arrays, e.g., memory array 810, include stored weight data elements that are applied in MAC operations to one or more sets of input data elements.

Memory array 810 is configured to store data elements DE, also referred to as input data elements IDE and weight data elements WDE. The input data elements IDE and weight data elements WDE correspond to respective input and weight data of one or more matrix computations.

MAC unit 820 is an electronic circuit, e.g., an IC, including one or more data registers and logic circuits configured to receive input data elements IDE and weight data elements WDE, e.g., from memory array 810, and perform a series of MAC calculations based on input data elements IDE and weight data elements WDE.

MAC unit 820 is configured to store a number W of weight data elements WDE on one or more data registers, also referred to as a weight buffer in some embodiments. Each input data element IDE has a number K bits, and MAC unit 820 is configured to receive and store the kth bit of each input data element IDE in one or more data registers. In various embodiments, MAC unit 820 includes a selection circuit configured to, in operation, sequentially select each kth bit or is configured to receive the kth bits of input data elements IDE sequentially in operation. In various embodiments, MAC unit 820 is configured to select or receive the kth bits in LSB to MSB order or MSB to LSB order.

MAC unit 820 includes the one or more logic circuits configured to, in operation, sequentially select each weight data element WDE, and for each selected weight data element WDE, perform a partial sum calculation by multiplying the selected weight data element WDE with each of the sequentially received and stored kth bits of the K bits of each input data element IDE to generate a series of K products.

MAC unit 820 includes one or more logic circuits configured to, in operation, sequentially add each of the products to a sum of the previously generated products as shifted in accordance with the LSB to MSB or MSB to LSB order of the kth bit sequencing. The one or more logic circuits are configured to output the sum of the K products as a partial sum PSUM.

MAC unit 820 is configured to repeat the partial sum calculation for each of the W weight data elements WDE, and is thereby configured to generate and output a sequence of W partial sums PSUM.

As a number of input data elements IDE increases, both the computational capacity and circuit complexity of MAC unit 820 increase. In some embodiments, input data elements IDE have a number ranging from eight to 256. In some embodiments, input data elements IDE have a number ranging from 16 to 128. In some embodiments, input data elements IDE have a number equal to 72.

Adder 830 is an electronic circuit, e.g., an IC, including one or more logic circuits configured to, in operation, receive each partial sum PSUM of the sequence of partial sums PSUM, and generate and output a corresponding sequence of accumulated sums ASUM by adding each partial sum PSUM to a stored accumulated sum SUM.

Buffer 840, also referred to as partial sum buffer 840 in some embodiments, is an electronic circuit, e.g., an IC, including one or more data registers and/or latches configured to, in operation, receive each accumulated sum ASUM and store each accumulated sum ASUM as stored accumulated sum SUM. Buffer 840 is configured to output stored accumulated sum SUM to an input port of adder 830 and to a circuit (not shown) external to CIM circuit 800, e.g., a memory array.

In a partial sum accumulation operation, buffer 840 is configured to generate stored accumulated sum SUM having an initial value of zero. After a total of W partial sum calculations have been performed corresponding to the W weight data elements WDE, buffer 840 is thereby configured to store and output stored accumulated sum SUM having a final accumulated sum ASUM of the sequence of accumulated sums ASUM, the final accumulated sum ASUM being equal to the sum of the partial sums PSUM.

In some embodiments, a total number of bits of each of accumulated sum ASUM and stored accumulated sum SUM is greater than a number of bits of partial sum PSUM. In some embodiments, the total number of bits of each of accumulated sum ASUM and stored accumulated sum SUM is equal to the number of bits of partial sum PSUM plus W.

As the number W of weight data elements WDE increases, both the computational capacity and circuit complexity of CIM circuit 800 increase. In some embodiments, the number W has a value ranging from four to 64. In some embodiments, the number W has a value ranging from eight to 32. In some embodiments, the number W is equal to 16.

By the configuration discussed above, CIM circuit 800 includes partial sum buffer 840 configured to accumulate multiple partial sum data elements prior to being output, e.g., to an external memory array, thereby reducing access power and time requirements compared to approaches in which individual partial sum data elements are output to an external memory array.

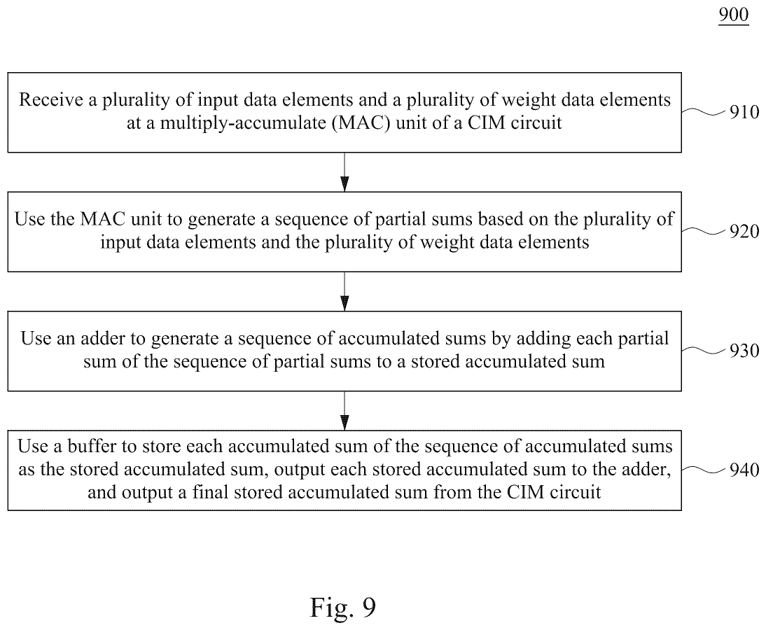

FIG. 9 is a flowchart of a method 900 of operating a memory circuit, in accordance with some embodiments. Method 900 is usable with a CIM circuit, e.g., CIM circuit 800 discussed above with respect to FIG. 8.

The sequence in which the operations of method 900 are depicted in FIG. 9 is for illustration only; the operations of method 900 are capable of being executed in sequences that differ from that depicted in FIG. 9. In some embodiments, operations in addition to those depicted in FIG. 9 are performed before, between, during, and/or after the operations depicted in FIG. 9. In some embodiments, the operations of method 900 are a subset of a method of performing a CNN operation.

At operation 910, a plurality of input data elements and a plurality of weight data elements are received at a MAC unit of a CIM circuit. In some embodiments, receiving the plurality of input data elements and the plurality of weight data elements at the MAC unit of the CIM circuit includes receiving input data elements IDE and weight data elements WDE at MAC unit 820 of CIM circuit 800 discussed above with respect to FIG. 8.

In some embodiments, receiving the plurality of input data elements and the plurality of weight data elements includes receiving the plurality of input data elements and the plurality of weight data elements from am memory array of the CIM circuit, e.g., memory array 810 discussed above with respect to FIG. 8.

At operation 920, the MAC unit is used to generate a sequence of partial sums based on the plurality of input data elements and the plurality of weight data elements. In some embodiments, using the MAC unit to generate the sequence of partial sums based on the plurality of input data elements and the plurality of weight data elements includes using MAC unit 820 to generate partial sums PSUM based on input data elements IDE and weight data elements WDE as discussed above with respect to FIG. 8.

At operation 930, an adder is used to generate a sequence of accumulated sums by adding each partial sum of the sequence of partial sums to a stored accumulated sum. In some embodiments, using the adder to generate the sequence of accumulated sums by adding each partial sum of the sequence of partial sums to the stored accumulated sum includes using adder 830 to generate sequence of accumulated sums ASUM by adding each partial sum PSUM to stored accumulated sum SUM as discussed above with respect to FIG. 8.

At operation 940, a buffer is used to store each accumulated sum of the sequence of accumulated sums as the stored accumulated sum, output each stored accumulated sum to the adder, and output a final stored accumulated sum from the CIM circuit. In some embodiments, using the buffer to store each accumulated sum of the sequence of accumulated sums as the stored accumulated sum, output each stored accumulated sum to the adder, and output the final stored accumulated sum from the CIM circuit includes using buffer 840 to store each accumulated sum ASUM as stored accumulated sum SUM, output each stored accumulated sum SUM to adder 830, and output the final stored accumulated sum SUM from CIM circuit 800 as discussed above with respect to FIG. 8.

By executing some of all of the operations of method 900, multiple partial sum data elements are accumulated prior to being output, e.g., to an external memory array, thereby realizing the benefits discussed above with respect to CIM circuit 800.

In some embodiments, a circuit includes a multiplier circuit configured to receive a signed mantissa of each data element of a plurality of input data elements and a plurality of weight data elements and generate a plurality of products by performing multiplication and reformatting operations on some or all of the signed mantissas of the plurality of input data elements and some or all of the signed mantissas of the plurality of weight data elements, a summing circuit configured to receive an exponent of each data element of the plurality of input data elements and the plurality of weight data elements, and generate a plurality of sums by adding each exponent of the plurality of input data elements to each exponent of the plurality of weight data elements, a shifting circuit configured to shift each product of the plurality of products by an amount equal to a difference between a corresponding sum of the plurality of sums and a maximum sum, and an adder tree configured to generate a mantissa sum from the plurality of shifted products. In some embodiments, the multiplier and summing circuits are configured to receive each data element of the plurality of input data elements and the plurality of weight data elements having a BF16 format, the multiplier circuit is configured to generate the plurality of products as 17-bit data elements, the summing circuit is configured to generate the plurality of sums as nine-bit data elements, the shifting circuit is configured to generate the plurality of shifted products as 21-bit data elements, and the adder tree is configured to generate the mantissa sum as a 25-bit data element. In some embodiments, the multiplier and summing circuits are configured to receive each data element of the plurality of input data elements and the plurality of weight data elements having a FP16 format, the multiplier circuit is configured to generate the plurality of products as 23-bit data elements, the summing circuit is configured to generate the plurality of sums as six-bit data elements, the shifting circuit is configured to generate the plurality of shifted products as 27-bit data elements, and the adder tree is configured to generate the mantissa sum as a 31-bit data element. In some embodiments, the multiplier circuit is configured to perform the multiplication and reformatting operations by reformatting the signed mantissas of the some or all of the pluralities of input and weight data elements to two's complement, and multiplying the some or all of the reformatted mantissas of the plurality of input data elements with the some or all of the reformatted mantissas of the plurality of weight data elements. In some embodiments, the multiplier circuit is configured to perform the multiplication and reformatting operations by generating a plurality of sign bits by performing an exclusive OR operation on sign bits of the signed mantissas of the some or all of the pluralities of input and weight data elements, generating a corresponding plurality of mantissa products by multiplying mantissa bits of the signed mantissas of the some or all of the plurality of input data elements with mantissa bits of the signed mantissas of the some or all of the plurality of weight data elements, and reformatting the pluralities of sign bits and mantissa products to two's complement. In some embodiments, the multiplier and summing circuits are configured to receive each of the plurality of input data elements and the plurality of weight data elements having a total of four data elements, the multiplier circuit is configured to perform a total of sixteen or fewer multiplication operations on the plurality of input data elements and the plurality of weight data elements, and the summing circuit is configured to perform a total of sixteen summing operations on the plurality of input data elements and the plurality of weight data elements. In some embodiments, the shifting circuit is configured to, for each product of the plurality of products, right-shift the product by the amount, add a number of leading sign bits to the shifted product, the number being equal to the amount, and add one or more trailing zero bits corresponding to the amount being less than a difference threshold. In some embodiments, the shifting circuit includes a first stage configured to generate a plurality of intermediate data elements from the plurality of products based on the two least significant bits of the corresponding differences, and a second stage configured to generate the plurality of shifted products from the plurality of intermediate data elements based on the other bits of the corresponding differences. In some embodiments, the circuit includes a difference circuit configured to determine the maximum sum of the plurality of sums, calculate each difference by subtracting the corresponding sum of the plurality of sums from the maximum sum, and output each difference to the shifting circuit. In some embodiments, the shifting circuit is configured to, for each difference, based on the difference being less than a difference threshold, generate the corresponding shifted product of the plurality of shifted products from the corresponding product of the plurality of products, or based on the difference being greater than or equal to the difference threshold, generate the corresponding shifted product of the plurality of shifted products as a zero-value data element. In some embodiments, the multiplier circuit is configured to receive each difference from the difference circuit, and for each difference, perform the multiplication and reformatting operations on the corresponding input and weight data elements only if the difference is less than a difference threshold. In some embodiments, the circuit is configured to convert the mantissa sum to a sign bit plus a plurality of mantissa bits.

In some embodiments, a method of operating a circuit includes receiving a signed mantissa and exponent of each data element of a plurality of input data elements and a plurality of weight data elements, generating a plurality of two's complement products by performing multiplication and reformatting operations on some or all of the signed mantissas of the plurality of input data elements and some or all of the signed mantissas of the plurality of weight data elements, generating a plurality of sums by adding each exponent of the plurality of input data elements to each exponent of the plurality of weight data elements, shifting each product of the plurality of products by an amount equal to a difference between a corresponding sum of the plurality of sums and a maximum sum, and summing the plurality of shifted products to generate a mantissa sum. In some embodiments, the circuit includes a memory array, and receiving the signed mantissa and exponent of each data element includes receiving each data element from the plurality of input data elements and the plurality of weight data elements stored in the memory array. In some embodiments, receiving the signed mantissa and exponent of each data element includes receiving each data element of the plurality of input data elements and the plurality of weight data elements having either a BF16 format or a FP16 format. In some embodiments, generating the plurality of products includes, for each difference between the corresponding sum of the plurality of sums and the maximum sum, performing the multiplication and reformatting operations on the corresponding input and weight data elements only if the difference is less than a difference threshold. In some embodiments, shifting each product of the plurality of products includes generating an intermediate data element from the product based on the two least significant bits of the corresponding difference, and generating the corresponding shifted product from the intermediate data element based on the other bits of the corresponding difference. In some embodiments, the method includes converting the mantissa sum to a sign bit plus a plurality of mantissa bits.

In some embodiments, a CIM circuit includes a memory array configured to store a plurality of input data elements and a plurality of weight data elements, a MAC unit configured to generate a sequence of partial sums based on the plurality of input data elements and the plurality of weight data elements, an adder configured to generate a sequence of accumulated sums by adding each partial sum of the sequence of partial sums to a stored accumulated sum, and a buffer configured to store each accumulated sum of the sequence of accumulated sums as the stored accumulated sum, output each stored accumulated sum to the adder, and output a final stored accumulated sum from the CIM circuit. In some embodiments, the buffer is configured to output the final stored accumulated sum to a memory array of another CIM circuit.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A circuit comprising:
a multiplier circuit configured to:
receive a signed mantissa of each data element of a plurality of input data elements and a plurality of weight data elements, and
generate a plurality of two's complement products by performing multiplication and reformatting operations on some or all of the signed mantissas of the plurality of input data elements and some or all of the signed mantissas of the plurality of weight data elements;
a summing circuit configured to:
receive an exponent of each data element of the plurality of input data elements and the plurality of weight data elements, and
generate a plurality of sums by adding each exponent of the plurality of input data elements to each exponent of the plurality of weight data elements;
a shifting circuit configured to shift each product of the plurality of products by an amount equal to a difference between a corresponding sum of the plurality of sums and a maximum sum; and
an adder tree configured to generate a mantissa sum from the plurality of shifted products.

2. The circuit of claim 1, wherein
the multiplier and summing circuits are configured to receive each data element of the plurality of input data elements and the plurality of weight data elements having a BF16 format,
the multiplier circuit is configured to generate the plurality of products as 17-bit data elements,
the summing circuit is configured to generate the plurality of sums as nine-bit data elements,
the shifting circuit is configured to generate the plurality of shifted products as 21-bit data elements, and
the adder tree is configured to generate the mantissa sum as a 25-bit data element.

3. The circuit of claim 1, wherein
the multiplier and summing circuits are configured to receive each data element of the plurality of input data elements and the plurality of weight data elements having a FP16 format,
the multiplier circuit is configured to generate the plurality of products as 23-bit data elements,
the summing circuit is configured to generate the plurality of sums as six-bit data elements,
the shifting circuit is configured to generate the plurality of shifted products as 27-bit data elements, and
the adder tree is configured to generate the mantissa sum as a 31-bit data element.

4. The circuit of claim 1, wherein the multiplier circuit is configured to perform the multiplication and reformatting operations by
reformatting the signed mantissas of the some or all of the pluralities of input and weight data elements to two's complement, and
multiplying the some or all of the reformatted mantissas of the plurality of input data elements with the some or all of the reformatted mantissas of the plurality of weight data elements.

5. The circuit of claim 1, wherein the multiplier circuit is configured to perform the multiplication and reformatting operations by
generating a plurality of sign bits by performing an exclusive OR operation on sign bits of the signed mantissas of the some or all of the pluralities of input and weight data elements,
generating a corresponding plurality of mantissa products by multiplying mantissa bits of the signed mantissas of the some or all of the plurality of input data elements with mantissa bits of the signed mantissas of the some or all of the plurality of weight data elements, and
reformatting the pluralities of sign bits and mantissa products to two's complement.

6. The circuit of claim 1, wherein
the multiplier and summing circuits are configured to receive each of the plurality of input data elements and the plurality of weight data elements having a total of four data elements,
the multiplier circuit is configured to perform a total of sixteen or fewer multiplication operations on the plurality of input data elements and the plurality of weight data elements, and
the summing circuit is configured to perform a total of sixteen summing operations on the plurality of input data elements and the plurality of weight data elements.

7. The circuit of claim 1, wherein the shifting circuit is configured to, for each product of the plurality of products:
right-shift the product by the amount,
add a number of leading sign bits to the shifted product, the number being equal to the amount, and
add one or more trailing zero bits corresponding to the amount being less than a difference threshold.

8. The circuit of claim 1, wherein the shifting circuit comprises:
a first stage configured to generate a plurality of intermediate data elements from the plurality of products based on the two least significant bits of the corresponding differences, and
a second stage configured to generate the plurality of shifted products from the plurality of intermediate data elements based on the other bits of the corresponding differences.

9. The circuit of claim 1, further comprising a difference circuit configured to:
determine the maximum sum of the plurality of sums,
calculate each difference by subtracting the corresponding sum of the plurality of sums from the maximum sum, and
output each difference to the shifting circuit.

10. The circuit of claim 9, wherein the shifting circuit is configured to, for each difference:
based on the difference being less than a difference threshold, generate the corresponding shifted product of the plurality of shifted products from the corresponding product of the plurality of products, or
based on the difference being greater than or equal to the difference threshold, generate the corresponding shifted product of the plurality of shifted products as a zero-value data element.

11. The circuit of claim 9, wherein the multiplier circuit is configured to:
receive each difference from the difference circuit, and
for each difference, perform the multiplication and reformatting operations on the corresponding input and weight data elements only if the difference is less than a difference threshold.

12. The circuit of claim 1, wherein the circuit is configured to convert the mantissa sum to a sign bit plus a plurality of mantissa bits.

13. A method of operating a circuit, the method comprising:
receiving a signed mantissa and exponent of each data element of a plurality of input data elements and a plurality of weight data elements;
generating a plurality of two's complement products by performing multiplication and reformatting operations on some or all of the signed mantissas of the plurality of input data elements and some or all of the signed mantissas of the plurality of weight data elements;
generating a plurality of sums by adding each exponent of the plurality of input data elements to each exponent of the plurality of weight data elements;
shifting each product of the plurality of products by an amount equal to a difference between a corresponding sum of the plurality of sums and a maximum sum; and
summing the plurality of shifted products to generate a mantissa sum.

14. The method of claim 13, wherein
the circuit comprises a memory array, and
the receiving the signed mantissa and exponent of each data element comprises receiving each data element from the plurality of input data elements and the plurality of weight data elements stored in the memory array.

15. The method of claim 13, wherein
the receiving the signed mantissa and exponent of each data element comprises receiving each data element of the plurality of input data elements and the plurality of weight data elements having either a BF16 format or a FP16 format.

16. The method of claim 13, wherein the generating the plurality of two's complement products comprises:
for each difference between the corresponding sum of the plurality of sums and the maximum sum, performing the multiplication and reformatting operations on the corresponding input and weight data elements only if the difference is less than a difference threshold.

17. The method of claim 13, wherein the shifting each product of the plurality of products comprises:
generating an intermediate data element from the product based on the two least significant bits of the corresponding difference; and
generating the corresponding shifted product from the intermediate data element based on the other bits of the corresponding difference.

18. The method of claim 13, further comprising converting the mantissa sum to a sign bit plus a plurality of mantissa bits.

19. A compute-in-memory (CIM) circuit comprising:
a memory array configured to store a plurality of input data elements and a plurality of weight data elements;
a multiply-accumulate (MAC) unit configured to generate a sequence of partial sums based on the plurality of input data elements and the plurality of weight data elements;
an adder configured to generate a sequence of accumulated sums by adding each partial sum of the sequence of partial sums to a stored accumulated sum; and
a buffer configured to
store each accumulated sum of the sequence of accumulated sums as the stored accumulated sum,
output each stored accumulated sum to the adder, and
output a final stored accumulated sum from the CIM circuit.

20. The CIM circuit of claim 19, wherein the buffer is configured to output the final stored accumulated sum to a memory array of another CIM circuit.
